(19) United States
(12) Patent Application Publication
(10) Pub. No.: US 2003/0202176 A1
(43) Pub. Date: Oct. 30, 2003

(54) Optical power meter

(76) Inventor: Katushi Ohta, Kosai-shi (JP)

Correspondence Address: FISH & RICHARDSON P.C., 45 ROCKEFELLER PLAZA, SUITE 2800, NEW YORK, NY, 10111, US

(21) Appl. No.: 10/425,407

(22) Filed: Apr. 29, 2003

(30) Foreign Application Priority Data
Apr. 30, 2002 (JP) P. 2002-128842

(51) Int. Cl. G01J 1/42

(52) U.S. Cl. 356/224

(57) ABSTRACT

An optical power meter is provided which can measure with high accuracy a power of a light-to-be-measured containing a plurality of wavelength of light and light-to-be-measured having a broad wavelength region without incurring cost rise and without the necessity for the user to input an wavelength of a light-to-be-measured. In an optical power meter for measuring a power of a light-to-be-measured, there are provided a photodiode having a sensitivity characteristic that sensitivity changes in accordance with a wavelength of a light incident on a light-receiving surface and a dielectric multi-layered film filter arranged on a side of the light-receiving surface of the photodiode and having a wavelength characteristic substantially reverse to the sensitivity characteristic of the photodiode.

### BACKGROUND OF THE INVENTION

1. Technical Field of the Invention

This invention relates to an optical power meter capable of measuring a power of a light-to-be-measured containing a plurality of wavelengths of light.

2. Description of the Related Art

Conventionally, the optical power meter is used for measuring a power of light in the field of optical studies. Due to the recent progress in the optical communication technology using the optical fibers, there are increasing occasions using those in order to measure a power of a light propagating through the optical fiber. The power measurement of a light-to-be-measured by the use of an optical power meter is conducted after inputting to an optical power meter a wavelength of a light-to-be-measured by the user.

This is because a photodiode (PD) provided on the optical power meter has an on-wavelength dependence in its sensitivity characteristic (photoelectric conversion characteristic) and hence correction is made on a detection result of photodiode depending upon a wavelength of the input light. Also, in the case that the optical part, such as a lens, has an on-wavelength dependence in its transmission or reflection characteristic, correction in a certain cases is onto such on-wavelength dependence.

In order to correct a detection result of the photodiode, there is employed, for example, a method that the amplifying factor of an output current of photodiode or the amplifying factor of after conversion of an output current of photodiode into a voltage is varied depending upon an input wavelength, or a method that, after converting a detection result of photodiode into a digital signal, operation process is made on the digital signal in accordance with an input wavelength. The corrected detection result is displayed as a power of the measured light, on a display device. In this manner, in the conventional optical power meter, a predetermined operation or process is carried out on the detection result of photodiode, thereby correcting the on-wavelength dependence of photodiode or the like.

In the meanwhile, recently the wavelength multiplex technique is used in order to increase communications capacity. Particularly, it is a general practice to use the wavelength multiplex technique over the trunk line, called the backbone. The wavelength multiplex technique uses ten and several to several tens of different wavelengths of light. The optical power meter, for measuring a power of a waveform-multiplexed light-to-be-measured, is required to correctly measure a power on every wavelength of light included in the light-to-be-measured.

With the conventional power meter, however, when measuring a power on a light-to-be-measured, measurement is conducted after inputting a wavelength of the light-to-be-measured to the optical power meter by the user, as noted before. There is a problem that, where measuring a light-to-be-measured containing a plurality of wavelength of light, the wavelength the user is to input is not to be known. In the case to measure such a light-to-be-measured, a certain degree of possibly correct measurement result is to be obtained by inputting a center wavelength of light contained in the light-to-be-measured. However, this is far from a correct measurement of a power on the light-to-be-measured.

Meanwhile, in case the power meter is structured to separate the light portions contained in the light-to-be-measured on each wavelength basis and individually measure them in a manner summing up the measurement results, it is possible to accurately measure a power on the light-to-be-measured. In the case the optical power meter is constructed in such a structure, there would be encountered a problem of rising up of optical power meter cost.

### SUMMARY OF THE INVENTION

It is an object of the present invention to provide an optical power meter which can measure with high accuracy a power of a light-to-be-measured containing a plurality of wavelengths of light and light-to-be-measured having a broad wavelength region freely from incurring cost rise without the necessity for the user to input an wavelength of a light-to-be-measured.

In order to solve the problem, an optical power meter of the present invention is, in an optical power meter for measuring a power of a light-to-be-measured (IL), an optical power meter comprising: a light-receiving element (22, 32) having a sensitivity characteristic that sensitivity changes in accordance with a wavelength of a light incident on a light-receiving surface (22a, 32a); and a correcting member (20, 30) arranged on a side of the light-receiving surface of the light-receiving element and having a wavelength characteristic substantially reverse to the sensitivity characteristic of the light-receiving element.

According to this invention, there is provided a correcting member having a wavelength characteristic substantially reverse to the sensitivity characteristic of the light-receiving element to thereby correct the sensitivity characteristic of the light-receiving element. Accordingly, it is possible to accurately measure a power of a light-to-be-measured containing a plurality of wavelengths of light and light-to-be-measured having a broad wavelength region. Also, by merely providing a correcting member, corrected is the sensitivity characteristic of the light-receiving element. Moreover, because it is possible to eliminate the structure for correcting a detection result of light-receiving element as provided on the conventional power meter, there is no possibility to incur a cost rise of optical power meter. Furthermore, conventionally there is a need for the user to input a wavelength of light-to-be-measured, in order to correct the sensitivity characteristic of light-receiving element. However, in the invention, because the correct member corrects the sensitivity characteristic of light-receiving element, such input is not required. This makes it possible to efficiently measure on a light-to-be-measured without requiring labor and time.

Also, in the optical power meter of the invention, the correcting member is preferably a dielectric multi-layered film filter having a transmission characteristic set substantially reverse in wavelength characteristic to a sensitivity characteristic of the light-receiving element.

Otherwise, in the optical power meter of the invention, the correcting member is preferably an integrating sphere which reflects and scatters an incident light at an inside thereof, to provide a light intensity distribution substantially uniform at the inside.

Herein, the integrating sphere is characterized by having a transmission characteristic set substantially reverse in wavelength characteristic to the sensitivity characteristic of the light-receiving element.

Also, in the optical power meter of the invention, the light-receiving element is suitably an element having a high light-receiving sensitivity in a wavelength region included in a wavelength region of from 1450 nm to 1650 nm.

### BRIEF DESCRIPTION OF THE DRAWINGS

FIG. 1 is a block diagram showing a schematic configuration of an optical power meter according to a first embodiment of the present invention;

FIG. 2 is a structure showing a construction of a light-receiving section provided in an optical power meter according to the first embodiment of the invention;

FIG. 3 is a figure showing a relationship between a transmission characteristic of a dielectric multi-layered film filter 20 and a sensitivity characteristic of a photodiode 22 on the optical power meter according to the first embodiment of the invention;

FIG. 4 is a structure showing a construction of a light-receiving section provided in an optical power meter according to a second embodiment of the invention;

FIG. 5 is a figure showing a relationship between a transmission characteristic of an integrating sphere 30 and a sensitivity characteristic of a photodiode 32 on the optical power meter according to the second embodiment of the invention; and

FIG. 6 is a diagram schematically showing an example of actual attenuation characteristic of an integrating sphere 30.

### DESCRIPTION OF THE PREFERRED EMBODIMENTS

Explanation will be now made on an optical power meter according to the embodiment of the present invention, with reference to the drawings.

[First Embodiment]

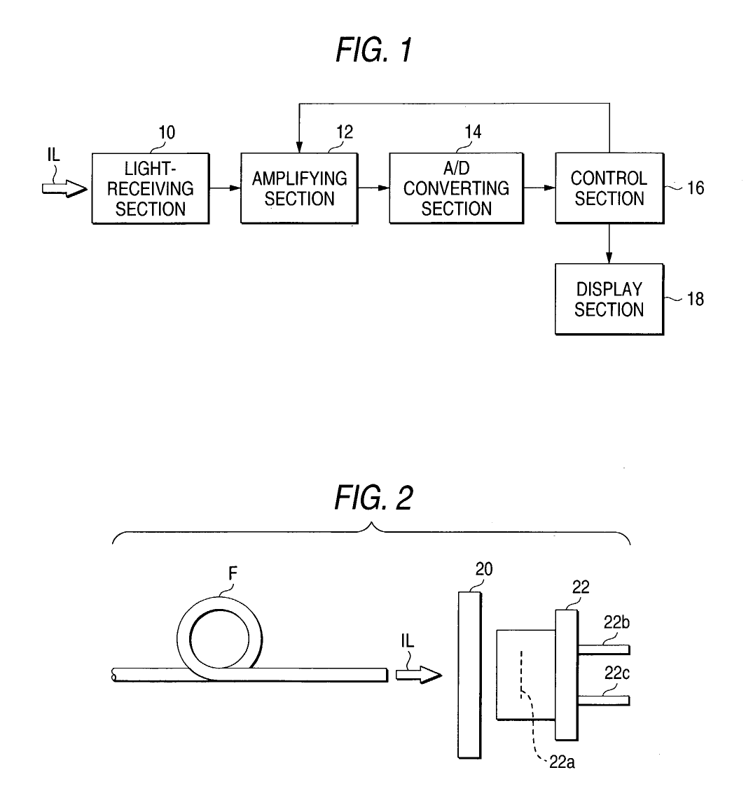

FIG. 1 is a block diagram showing a schematic configuration of an optical power meter according to a first embodiment of the invention. As shown in FIG. 1, the optical power meter of this embodiment is configured including a light-receiving section 10, an amplifying section 12, an A/D converting section 14, a control section 16 and a display section 18.

The light-receiving section 10 comprises a photodiode (PD) for example, to receive and photoelectrically convert a light-to-be-measured IL thereby outputting a detection signal commensurate with a power (light intensity) of the light-to-be-measured IL. The amplifying section 12 amplifies the detection signal outputted from the light-receiving section 10, at a predetermined amplification factor. The amplifying section 12 is configured to vary stepwise the amplification ratio. The amplification factor, for a detection signal in the amplifying section 12, is under control of the control section 16.

The A/D converting section 14 converts the detection signal amplified by the amplifying section 12 into a digital signal. The control section 16 sets the amplifying section 12 with an amplification factor suited for a light-reception level of light-to-be-measured IL, according to a value of the digital signal outputted from the A/D converting section 14.

Meanwhile, the control section 16 makes a conversion process (e.g. process such as logarithmic transformation) based on a predetermined conversion rule on a digital signal outputted from the A/D converting section 14, and converts a value of digital signal into a value representative of a power of light-to-be-measured IL. The display section 18 is configured, for example, by a liquid crystal display, a plasma display, an LED (light emitting diode) display or other display, to make a display representing a power of light-to-be-measured IL, on the basis of a signal outputted from the control section 16.

Now, explanation is made on the configuration of the light-receiving section 10 as a characterized part of the optical power meter of the first embodiment of the invention. FIG. 2 is a view showing a structure of the light-receiving section provided in the optical power meter of the first embodiment of the invention. Incidentally, FIG. 2 exemplifies a case that a light-to-be-measured IL is guided to the light-receiving section 10 through an optical fiber F.

As shown in FIG. 2, the light-receiving section 10, provided in the optical power meter of this embodiment, is configured including a dielectric multi-layered film filter 20 as a correcting member and a photodiode 22 as a light-receiving element. The dielectric multi-layered film filter 20 is formed by laminating nearly a hundred dielectric layers in different kind (e.g. SiO₂ and TiO₂).

Meanwhile, the photodiode 22 converts the light incident on a light-receiving surface 22a into an electric current and outputs it at its output terminals 22b, 22c. As shown in FIG. 2, the dielectric multi-layered film filter 20 is arranged on the side of the light-receiving surface 22a of photodiode 22, allowing only the light transmitted the dielectric multi-layered film filter 20 to enter the light-receiving surface 22a of photodiode 22.

The photodiode 22 is an element formed, for example, of an InGaAs-based material, to have a high light-receiving sensitivity in a wavelength region of from approximately 1450 nm to approximately 1600 nm. Also, the photodiode 22 has a sensitivity characteristic that the sensitivity changes depending upon a wavelength of the light incident upon the light-receiving surface 22a. The present embodiment is characterized most in that the dielectric multi-layered film filter 20 has a transmission characteristic (wavelength characteristic) nearly reverse to the sensitivity characteristic of photodiode 22.

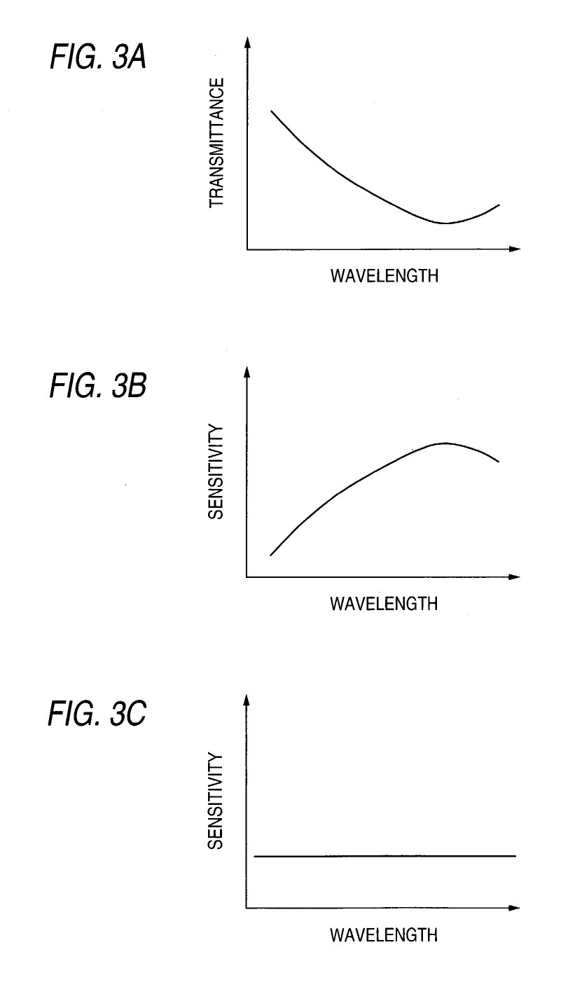

Herein, explanation is made on the relationship between a transmission characteristic of the dielectric multi-layered film filter 20 and a sensitivity characteristic of the photodiode 22. FIG. 3 is a diagram showing a relationship between a transmission characteristic of the dielectric multi-layered film filter 20 and a sensitivity characteristic of the photodiode 22, in the optical power meter of the first embodiment of the invention. FIG. 3A shows an example of transmission characteristic of the dielectric multi-layered film filter 20 while FIG. 3B an example of sensitivity characteristic of the photodiode 22.

As shown in FIG. 3B, the photodiode 22 has a sensitivity characteristic that, for example, the sensitivity is low in a wavelength region at around 1450-nm band but the sensitivity increases as the wavelength region becomes longer in wavelength and again decreases in a wavelength region, for example, at around 1600-nm band. Contrary to this, the dielectric multi-layered film filter 20 has a characteristic, as shown in FIG. 3A, that the sensitivity is high in a wavelength region at around 1450-nm band but the sensitivity decreases as the wavelength region becomes longer in wavelength and again increases in a wavelength region, for example, at around 1600-nm band. In this manner, the transmission characteristic of the dielectric multi-layered film filter 20 is nearly reverse to the sensitivity characteristic of the photodiode 22.

FIG. 3C is a figure showing an example of sensitivity characteristic that the dielectric multi-layered film filter 20 and the photodiode 22 are considered as one light-receiving element. As can be seen from FIG. 3C, the light-receiving element comprising the dielectric multi-layered film filter 20 and the photodiode 22 has a sensitivity almost constant, for example, in a wavelength region of from approximately 1450 nm to approximately 1600 nm. It can be seen that the photodiode 22 is eliminated of an on-wavelength dependence in sensitivity characteristic.

As explained above, in the optical power meter of the first embodiment of the invention, there is provided a dielectric multi-layered film filter 20 having a transmission characteristic nearly reverse to the sensitivity characteristic of the photodiode 22, to receive the light-to-be-measured IL transmitted the dielectric multi-layered film filter 20 by the photodiode 22. This makes it possible to eliminate the photodiode 22 of an on-wavelength dependence in sensitivity characteristic. Accordingly, even where the light-to-be-measured IL contains a plurality of wavelengths or has a broad wavelength region, power measurement is possible accurately on every power of the light-to-be-measured IL.

Also, because differently from the conventional there is no need to correct the detection signal outputted from the photodiode (light-receiving section) 22 according to a wavelength, it is possible to simplify the device structure and resultingly reduce the cost. Furthermore, because there is no need for the user to input a wavelength of light-to-be-measured IL, it is possible to greatly relieve the user of labor and time during measurement.

[Second Embodiment]

Now, explanation is made on an optical power meter according to a second embodiment of the invention. Note that the optical power meter of this embodiment is similar in schematic configuration to the power meter of the first embodiment but different in the internal configuration of the light-receiving section 10. The optical power meter of the second embodiment of the invention is explained below, centering on its internal configuration of the light-receiving section 10.

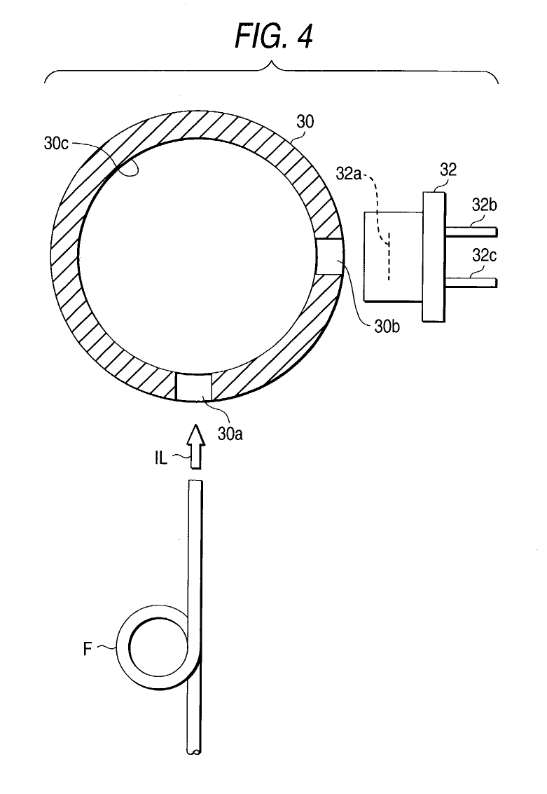

FIG. 4 shows a structure of the light-receiving section provided in the optical power meter of the second embodiment of the invention. Incidentally, FIG. 4 also exemplifies a case that the light-to-be-measured IL is guided to the light-receiving section 10 through an optical fiber F. As shown in FIG. 4, the light-receiving section 10 provided in the optical power meter of this embodiment includes an integrating sphere 30 as a correcting member and a photodiode 32 as a light-receiving element.

The integrating sphere 30 is a member in a spherical shell form formed, for example, of tetrafluoroethyl resin or a material similar thereto or barium sulfate or a material similar thereto. The integrating sphere 30 is formed with a light input part 30a and output part 30b at a predetermined position of the sphere. This has a characteristic that the incident light is reflected (irregularly reflected) and scattered upon an inner surface 30c to provide a nearly uniform distribution of light intensity at the inside of the integrating sphere 30. Incidentally, the integrating sphere 30 also has a characteristic to turn the polarization state of incident light into a non-polarization state.

Meanwhile, the integrating sphere 30 has a characteristic that, concerning the reflectance on its inner surface 30a, the reflectance is high for a certain wavelength of light but not so high for another wavelength of light. This characteristic stems mainly from the reflecting characteristic of a material forming the integrating sphere 30. Accordingly, the transmission characteristic is given with on-wavelength dependence in accordance with the material.

The photodiode 32 converts the light incident on the light-receiving surface 32a into an electric current and outputs it at the output terminals 32b, 32c. As shown in FIG. 4, the optical fiber F is arranged in a vicinity of the input part 30a of the integrating sphere 30 while the photodiode 32 is close to the output part 30b of the integrating sphere 30. In this manner, the output part 30b of the integrating sphere 30 is arranged on the side close to the light-receiving surface 32a. Of the light-to-be-measured IL guided by the optical fiber F and entered into the integrating sphere 30 at the input part 30a of the integration sphere 30, only the light-to-be-measured IL exited at the output part 30b of the integrating sphere 30 can enter the light-receiving surface 32a of the photodiode 32.

The photodiode 32 is formed with a strained quantium well structure, for example, of an InGaAs-based material, which is an element having a high light-receiving sensitivity in a wavelength range of from approximately 1450 nm to approximately 1650 nm. The photodiode 32 is enhanced in sensitivity in a region having longer wavelength than the photodiode 22 of the foregoing first embodiment (herein, in a region of longer wavelength than 1600 nm or the around).

However, the photodiode 32 also has a sensitivity characteristic that the sensitivity varies with a wavelength of a light incident on the light-receiving surface 32a. This embodiment is characterized most in that the transmission characteristic (or attenuation characteristic) of the integrating sphere 30 has a transmission characteristic nearly reverse to the sensitivity characteristic of the photodiode 32.

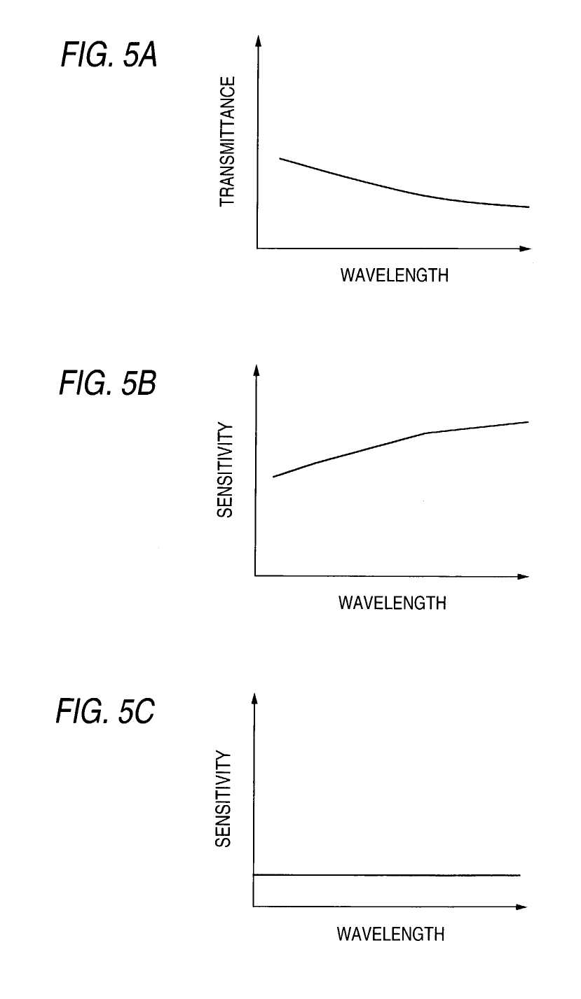

Herein, explanation is made on the relationship between a transmission characteristic of the integrating sphere 30 and a sensitivity characteristic of the photodiode 32. FIG. 5 is a diagram showing a relationship between a transmission characteristic of the integrating sphere 30 and a sensitivity characteristic of the photodiode 32, in the optical power meter of the second embodiment of the invention. FIG. 5A shows an example of transmission characteristic of the integrating sphere 30 while FIG. 5B an example of sensitivity characteristic of the photodiode 32.

As shown in FIG. 5B, the photodiode 32 has a characteristic that, for example, the sensitivity is low in a wavelength region at around 1450-nm band but the sensitivity increases as the wavelength region becomes longer in wavelength. As can be seen from a comparison between FIG. 5B and FIG. 3C, the photodiode 32 is free from the lower of sensitivity in a wavelength region at around 1600-nm band or higher, for example. Contrary to this, the integrating sphere 30 has a characteristic, as shown in FIG. 5A, that the sensitivity is high in a wavelength region, for example, at around 1450-nm band but the sensitivity decreases as the wavelength region becomes longer in wavelength. In this manner, the transmission characteristic of the integrating sphere 30 has a wavelength characteristic nearly reverse to the sensitivity characteristic of the photodiode 32.

FIG. 5C is a figure showing an example of sensitivity characteristic that the integrating sphere 30 and the photodiode 32 are considered as one light-receiving element. As can be seen from FIG. 5C, the light-receiving element comprising the integrating sphere 30 and the photodiode 32 has a sensitivity almost constant, for example, in a wavelength region of from approximately 1450 nm to approximately 1650 nm. It can be seen that the photodiode 32 is eliminated of an on-wavelength dependence in sensitivity characteristic.

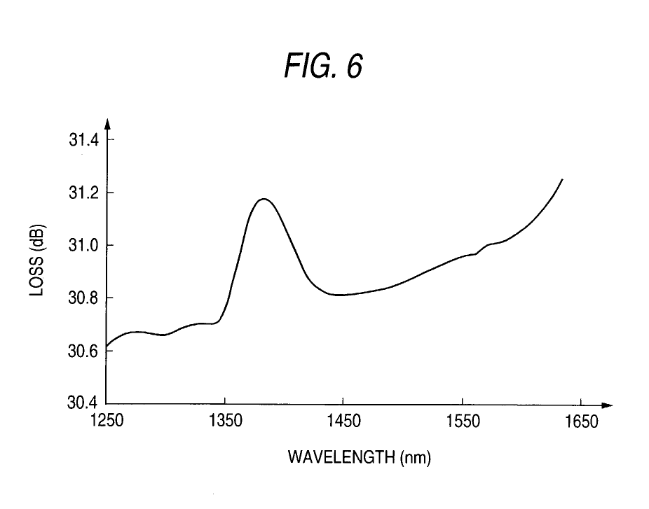

FIG. 6 is a diagram typically showing an example of actual attenuation characteristic on the integrating sphere 30. As can be seen from FIG. 6, the attenuation amount (loss amount) increases proportionally with increase of the wavelength, except in a wavelength region of from 1350-nm band or its around to 1430-nm band or its around. Namely, as the wavelength increases, the attenuation amount increases to lower the transmittance. It can be seen that it has a characteristic similar to the transmission characteristic shown in FIG. 5A.

Particularly, in the wavelength region (1450 nm to 1650 nm) for use in the wavelength multiplex technique, because the loss amount nearly simply increases as the wavelength increases. Consequently, the light-receiving sensitivity can be given nearly constant throughout the wavelength region. Accordingly, the optical power meter of this embodiment can accurately measure a power of a light having multiplexed wavelengths.

Meanwhile, the attenuation amount of the light-receiving element comprising the integrating sphere 30 and the photodiode 32 is determined by an inner diameter of the integrating sphere 30, an area of the input part 30a, an area of the output part 30b and an area of the light-receiving surface 32a of the photodiode 32. Accordingly, by properly setting these, the integrating sphere 30 can be used also as an attenuator. Consequently, the optical power meter of this embodiment can be used in every field handling high power of light besides the optical communication field.

As explained above, in the optical power meter of the second embodiment of the invention, there is provided a integrating sphere 30 having a transmission characteristic nearly reverse to the sensitivity characteristic of the photodiode 32, to receive the light-to-be-measured IL transmitted the integrating sphere 30 by the photodiode 32. This makes it possible to eliminate the photodiode 32 of the on-wavelength dependence in sensitivity characteristic. Accordingly, even where the light-to-be-measured IL contains a plurality of wavelengths or has a broad wavelength region, it is possible to accurately measure every power of the light-to-be-measured IL.

Also, because there is no need to correct the detection signal outputted from the photodiode (light-receiving section) 32 depending upon a wavelength, it is possible to simplify the device structure and resultingly reduce the cost. Furthermore, because there is no need for the user to input a wavelength of light-to-be-measured IL, it is possible to greatly relieve the user in measurement of labor and time. Furthermore, because the integrating sphere 30 can be used also as an attenuator, application is possible for optical power measurement in a variety of technical fields without requiring great change to the optical power meter structure.

Although the above explained the optical power meter according one embodiment of the invention, the present invention is not limited to the above embodiments, i.e. design change is possible freely within the scope of the invention. For example, although the first and second embodiment used an optical fiber F to guide the light-to-be-measured IL to the light-receiving section 10 (dielectric multi-layered film filter 20 or integrating sphere 30), an arbitrary method can be employed as a method to guide the light-to-be-measured IL to the light-receiving section 10. Meanwhile, the light-receiving section 10 may use a lens to focus light. Also, the power meter of the invention can, of course, measure a power of a single wavelength of light. Furthermore, the wavelength region of light-to-be-measured IL is not limited to the wavelength region of the above embodiment (wavelength region of from 1450 nm to 1650 nm), i.e. it is possible to measure a power of an arbitrary wavelength region of light. In this case, it is satisfactory to provide a light-receiving element having a high light-receiving sensitivity in the wavelength region of the light-to-be-measured IL, wherein provided is a dielectric multi-layered film filter 20 or integrating sphere 30 having a wavelength characteristic nearly reverse to the sensitivity characteristic of that light-receiving element.

As explained in the above, the present invention provides an effect, i.e., because there is provided a correcting member having a wavelength characteristic substantially reverse to the sensitivity characteristic of the light-receiving element to thereby correct the sensitivity characteristic of the light-receiving element, it is possible to accurately measure a power of a light-to-be-measured containing a plurality of wavelengths of light and light-to-be-measured having a broad wavelength region.

Also, the invention provides an effect, i.e., by merely providing a correcting member, corrected is the sensitivity characteristic of the light-receiving element, and moreover, because it is possible to eliminate the structure for correcting a detection result of light-receiving element as provided on the conventional power meter, there is no possibility to incur a cost rise of optical power meter.

Furthermore, the invention provides an effect, i.e., although conventionally there is a need for the user to input a wavelength of light-to-be-measured in order to correct the sensitivity characteristic of light-receiving element because in the invention the correct member corrects the sensitivity characteristic of light-receiving element, such input is not required, it is possible to efficiently measure on a light-to-be-measured without requiring labor and time.

What is claimed is:

1. In an optical power meter for measuring a power of a light-to-be-measured, an optical power meter comprising:
a light-receiving element having a sensitivity characteristic that sensitivity changes in accordance with a wavelength of a light incident on a light-receiving surface; and
a correcting member arranged on a side of the light-receiving surface of the light-receiving element and having a wavelength characteristic substantially reverse to the sensitivity characteristic of the light-receiving element.

2. An optical power meter according to claim 1, wherein the correcting member is a dielectric multi-layered film filter having a transmission characteristic set substantially reverse in wavelength characteristic to a sensitivity characteristic of the light-receiving element.

3. An optical power meter according to claim 1, wherein the correcting member is an integrating sphere which reflects and scatters an incident light at an inside thereof, to provide a light intensity distribution substantially uniform at the inside.

4. An optical power meter according to claim 3, wherein the integrating sphere has a transmission characteristic set substantially reverse in wavelength characteristic to the sensitivity characteristic of the light-receiving element.

5. An optical power meter according to any of claims 1 to 4, wherein the light-receiving element is an element having a high light-receiving sensitivity in a wavelength region included in a wavelength region of from 1450 nm to 1650 nm.
